(19) United States
(12) Patent Application Publication
(10) Pub. No.: US 2011/0171964 A1
(43) Pub. Date: Jul. 14, 2011

(54) Resource allocation and signaling method for LTE sounding

(75) Inventors: Chih-Yuan Lin, Wujie Township (TW); Pei-Kai Liao, Mingjian Xiang (TW)

(73) Assignee: MEDIATEK Inc.

(21) Appl. No.: 12/930,449

(22) Filed: Jan. 7, 2011

Related U.S. Application Data
(60) Provisional application No. 61/293,416, filed on Jan. 8, 2010.
(60) Provisional application No. 61/372,658, filed on Aug. 11, 2010.

(51) Int. Cl. H04W 72/04

(52) U.S. Cl. 455/450

(57) ABSTRACT

A method of resource allocation for uplink channel sounding in a wireless communication system is provided. A base station (eNB) first selects a number of sounding reference signal (SRS) parameters. The eNB then determines a deviation set for each selected SRS parameter and jointly encodes the selected number of SRS parameters using a number of signaling bits. The signaling bits are transmitted to a user equipment (UE) for uplink channel sounding. Based on system requirements, some parameter combinations are filtered out and only necessary parameter combinations are jointly encoded such that the number of signaling bits is limited to a predefined number. In one embodiment, the signaling bits are contained in downlink control information (DCI) via a physical downlink control channel (PDCCH) for triggering Aperiodic SRS (ap-SRS). By jointly encoding selected SRS parameters, the eNB can dynamically configure ap-SRS parameters and resources for each UE with high flexibility and efficiency.

### CROSS REFERENCE TO RELATED APPLICATIONS

This application claims priority under 35 U.S.C. §119 from U.S. Provisional Application No. 61/293,416, entitled “Sounding Channel Design for LTE-A,” filed on Jan. 8, 2010; U.S. Provisional Application No. 61/372,658, entitled “Signaling Method for Rel-10 SRS,” filed on Aug. 11, 2010; the subject matter of which is incorporated herein by reference.

### TECHNICAL FIELD

The disclosed embodiments relate generally to wireless network communications, and, more particularly, to sounding channel resource allocation and signaling in LTE-A systems.

### BACKGROUND

Orthogonal Frequency-Division Multiple Access (OFDMA) is a multi-user version of the Orthogonal Frequency-Division Multiplexing (OFDM) digital modulation technology. In wireless OFDMA systems, however, multipath is an undesirable common propagation phenomenon that results in radio signals reaching the receiving antenna by two or more paths. Signal variations in amplitude or phase resulted from multipath are also referred as channel response. Transmission techniques, in which a transmitter makes use of the channel response between the transmitter and a receiver, are called close-loop transmission techniques. In multiple-input multiple-output (MIMO) applications, close-loop transmission techniques are much more robust as compared with open-loop MIMO techniques.

One method of providing channel information to the transmitter is via the use of an uplink (UL) sounding channel. Channel sounding is a signaling mechanism where a mobile station (also referred to as a user equipment (UE)) transmits sounding reference signals (SRS) on an uplink channel to enable a base station (also referred to as an eNodeB) to estimate the UL channel response. Channel sounding assumes the reciprocity of uplink and downlink channels, which is generally true in Time Division Duplexing (TDD) systems. Because the frequency bandwidth of the UL transmission encompasses the frequency bandwidth of the DL transmission in TDD systems, UL channel sounding can enable close-loop SU/MU-MIMO in downlink transmission based on channel state information (CSI) measured via SRS. UL channel sounding can also enable UL close-loop MIMO transmission in both TDD and Frequency Division Duplexing (FDD) systems. For example, the eNodeB can choose the best precoding weights (vectors/matrices) to be used for the UE based on CSI measured by SRS, such that the UE can perform close-loop SU/MU-MIMO in UL transmission. In TDD system, UL channel sounding can also be used for frequency selective scheduling, where the eNodeB schedules the UE to its best frequency band in both downlink and uplink transmissions.

In 3GPP LTE-A wireless communication systems, two types of SRS are defined. A first type of Periodic SRS (p-SRS) is used for obtaining long-term channel information. The periodicity of p-SRS is in general long (up to 320 ms) to reduce overhead. The p-SRS parameters are configured by higher layer radio resource control (RRC), so configuration time is long (e.g., 15-20 ms) and flexibility is low. For uplink MIMO supported in Release 10, p-SRS resource is highly demanded for close-loop spatial multiplexing, especially when the number of UEs becomes large. A second type of Aperiodic SRS (ap-SRS) is a new feature introduced in Release 10. Ap-SRS is triggered by uplink grant via physical downlink control channel (PDCCH). Once triggered, the UE transmits a sounding sequence in a pre-defined location. Ap-SRS supports multi-antenna sounding for uplink MIMO. Ap-SRS is much more flexible than p-SRS and can use residual resource that is not used by p-SRS. How to efficiently assign SRS resource for multiple antennas and how to efficiently signal ap-SRS parameters via uplink grant are problems faced in LTE sounding.

### SUMMARY

In accordance with a first novel aspect, a method of resource allocation for uplink channel sounding in a wireless communication system is provided. A base station (eNB) first selects a number of sounding reference signal (SRS) parameters. The eNB then determines a deviation set for each selected SRS parameter and jointly encodes the selected number of SRS parameters using a number of signaling bits. The signaling bits are transmitted to a user equipment (UE) for uplink sounding signal transmission. Based on system requirements, some unnecessary parameter combinations are filtered out and only necessary parameter combinations are kept such that the number of signaling bits is limited to a predefined number.

In one embodiment, the signaling bits are contained in downlink control information (DCI) via a physical downlink control channel (PDCCH) for triggering Aperiodic SRS (ap-SRS). In one example, the number of signaling bits is equal to two, and the selected parameters comprises an SRS bandwidth and an SRS frequency domain position. In another example, the number of signaling bits is equal to two, and the selected parameters comprises a transmission comb option and a cyclic shift option. By jointly encoding selected SRS parameters, the eNB can dynamically configure multiple ap-SRS parameters, rather than only one, and resources for each UE with high flexibility and efficiency.

In accordance with a second novel aspect, a method of multi-antenna resource allocation for uplink channel sounding in a wireless communication system is provided. A base station (eNB) first selects a number of sounding reference signal (SRS) parameters. The eNB then determines each selected SRS parameter for a first antenna of a user equipment (UE) having multiple antennas. The determined parameters are jointly encoded to a first set of parameter combination using a number of signaling bits. The eNB transmits the signaling bits for the first antenna to the UE without transmitting additional signaling bits for other antennas. The UE receives the signaling bits for SRS resource allocation for the first antenna and derives a second set of parameter combination for a second antenna based on a predetermined rule.

In one embodiment, the selected parameters comprise a cyclic shift (CS) option for SRS code sequence and a transmission comb option. The eNB multiplexes different antennas of different UEs in a CS domain such that the different antennas in the CS domain are evenly spaced with maximal possible CS spacing. In one example, the signaling bits are transmitted via a radio control channel (RCC) for configuring periodic SRS (p-SRS). In another example, the signaling bits are contained in downlink control information (DCI) and transmitted via a physical downlink control channel (PDCCH) for triggering Aperiodic SRS (ap-SRS). By implicitly signaling SRS resource allocation for multiple antennas, it is easy for the eNB to allocate SRS resource for different antennas of different UEs with reduced overhead.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates uplink channel sounding for downlink and uplink close-loop MIMO transmission in wireless communication systems in accordance with one novel aspect.

FIG. 2 illustrates an LTE-A wireless communication system with uplink channel sounding in accordance with one novel aspect.

FIG. 3 is a flow chart of a method of joint encoding for ap-SRS parameters by an eNB in accordance with one novel aspect.

FIG. 4 illustrates uplink channel sounding using ap-SRS via joint encoding/decoding in an LTE-A wireless communication system.

FIG. 5 illustrates a first embodiment of a signaling method for uplink channel sounding using joint encoding.

FIG. 6 illustrates a second embodiment of a signaling method for uplink channel sounding using joint encoding.

FIGS. 7 is a flow chart of a method of implicit signaling for multi-antenna SRS resource allocation by and eNB in accordance with one novel aspect.

FIG. 8 illustrates an implicit signaling method for multi-antenna SRS resource allocation in an LTE-A wireless communication system.

FIG. 9 illustrates a first embodiment of implicit signaling for multi-antenna SRS resource allocation in LTE sounding.

FIG. 10 illustrates a second embodiment of implicit signaling for multi-antenna SRS resource allocation in LTE sounding.

### DETAILED DESCRIPTION

Reference will now be made in detail to some embodiments of the invention, examples of which are illustrated in the accompanying drawings.

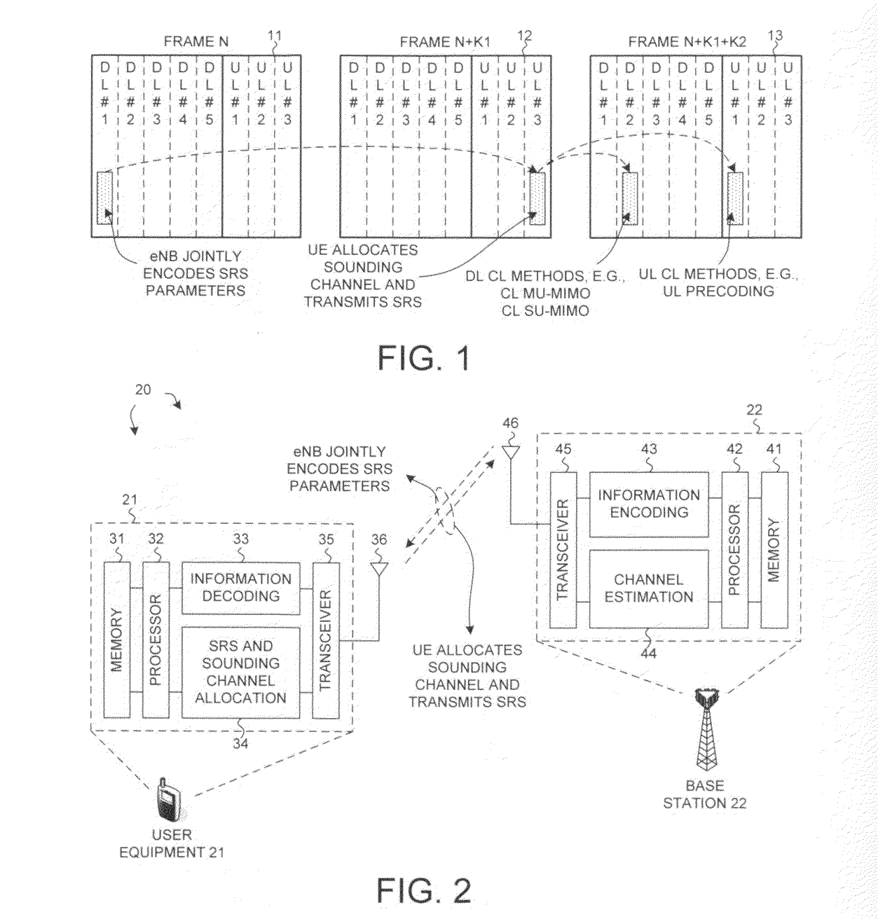

FIG. 1 illustrates uplink channel sounding for downlink and uplink close-loop MIMO transmission in wireless communication systems in accordance with one novel aspect. In wireless communication systems, a base station (also referred to as an eNB) and a mobile station (also referred to as a user equipment (UE)) communicate with each other by sending and receiving data carried in a series of frames. Each frame comprises a number of downlink (DL) subframes for the eNB to transmit data to the UE, and a number of uplink (UL) subframes for the UE to transmit data to the eNB. In the example of FIG. 1, the eNB jointly encodes a number of selected sounding reference signal (SRS) parameters and allocates SRS resource by transmitting an uplink grant in DL subframe DL#1 of frame 11 (frame N). Once triggered by the uplink grant, the UE decodes the SRS parameters and transmits a sounding signal via a sounding channel allocated in UL subframe UL#3 of a subsequent frame 12 (frame N+K1). The eNB receives the sounding signal and performs uplink channel estimation based on the received sounding signal. In another subsequent frame 13 (frame N+K1+K2), the eNB transmits data in DL subframe DL#2 using DL close-loop'transmission technique chosen based on the channel state information (CSI) obtained from the sounding channel, such as close-loop MU-MIMO or close-loop SU-MIMO. In addition, the UE transmits data in UL subframe UL#1 using UL close-loop transmission technique informed by the eNB, such as close-loop MIMO precoding. In accordance with one novel aspect, by jointly encoding the selected number of SRS parameters, SRS parameters can be signaled from the eNB to the UE via uplink grant much more efficiently with reduced overhead.

FIG. 2 illustrates an LTE-A wireless communication system 20 with uplink channel sounding in accordance with one novel aspect. LTE-A system 20 comprises a user equipment UE21 and a base station eNB22. UE21 comprises memory 31, a processor 32, an information decoding module 33, an SRS and sounding channel allocation module 34, and a transceiver 35 coupled to an antenna 36. Similarly, eNB22 comprises memory 41, a processor 42, an information encoding module 43, a channel estimation module 44, and a transceiver 45 coupled to an antenna 46. As illustrated above with respect to FIG. 1, base station eNB22 and user equipment UE21 communicate with each other by sending and receiving data carried in a series of frames. Each frame comprises a number of DL subframes and a number of UL subframes. For uplink sounding, eNB22 configures SRS parameters and allocating SRS resource by transmitting jointly encoded signaling information to UE21 in a DL subframe. Based on the signaling information, UE21 decodes the SRS parameters and transmits a sounding signal via a sounding channel in a UL subframe back to eNB22 for uplink channel estimation. In one or more exemplary embodiments, the functions described in the uplink sounding procedure may be implemented in hardware, software, firmware, or any combination thereof by the different modules. The functions described above may be implemented together in the same module, or implemented independently in separate modules.

In 3GPP LTE-A systems, two types of SRS are defined for uplink channel sounding. A first type of Periodic SRS (p-SRS) is used for obtaining long-term channel information. The periodicity of p-SRS is in general long (up to 320 ms). The p-SRS parameters are configured by higher layer radio resource control (RRC), so configuration time is long (e.g., 15-20 ms delay) and flexibility is low. A second type of Aperiodic SRS (ap-SRS) is dynamically triggered by an uplink grant from the eNB. The uplink channel sounding described above with respect to FIG. 1 is an example of sounding using ap-SRS. Once triggered, the UE transmits a sounding signal to the eNB in a pre-defined location.

For configuring p-SRS or ap-SRS parameters, two types of SRS parameters are defined in 3GPP LTE-A systems. A first type of cell-specific parameters includes SRS bandwidth configuration and SRS subframe configuration. The cell-specific parameters are used to define the overall SRS resource allocated in a cell served by an eNB. A second type of UE-specific parameters includes SRS bandwidth, SRS hopping bandwidth, frequency domain position, SRS configuration index, number of antenna ports, transmission comb, and cyclic shift (CS). The UE-specific parameters are used to define SRS resource allocation for each individual UE. The cell-specific parameters for p-SRS are re-used for ap-SRS because p-SRS and ap-SRS share the overall SRS resource. The UE-specific parameters for ap-SRS, however, are different from p-SRS such that ap-SRS can use residual resource that is not used by p-SRS by multiplexing between ap-SRS and p-SRS for each UE.

Ap-SRS is a new feature introduced in Release 10 that supports multi-antenna sounding for uplink MIMO. Ap-SRS is much more flexible than p-SRS and can use residual resource that is not used by p-SRS. Traditionally, p-SRS parameters are configured via RRC. To dynamically trigger and configure ap-SRS parameters, however, the use of higher layer RRC is no longer efficient because of the long latency. A faster physical layer signaling method is thus desirable for triggering ap-SRS and configuring UE-specific parameters. In one example, ap-SRS may be triggered via a physical downlink control channel (PDCCH) that provides reasonable flexibility. More specifically, a new n-bit field is added in downlink control information (DCI) format X to modify UE-specific parameters for ap-SRS. Due to PDCCH coverage, however, the number n should not be too large. In current 3GPP LTE-A systems, for example, the number n is determined to be two. In one novel aspect, a joint encoding method is utilized such that a selected number of SRS parameters can be jointly encoded using the new n-bit field in DCI format X and transmitted from the eNB to the UE via PDCCH.

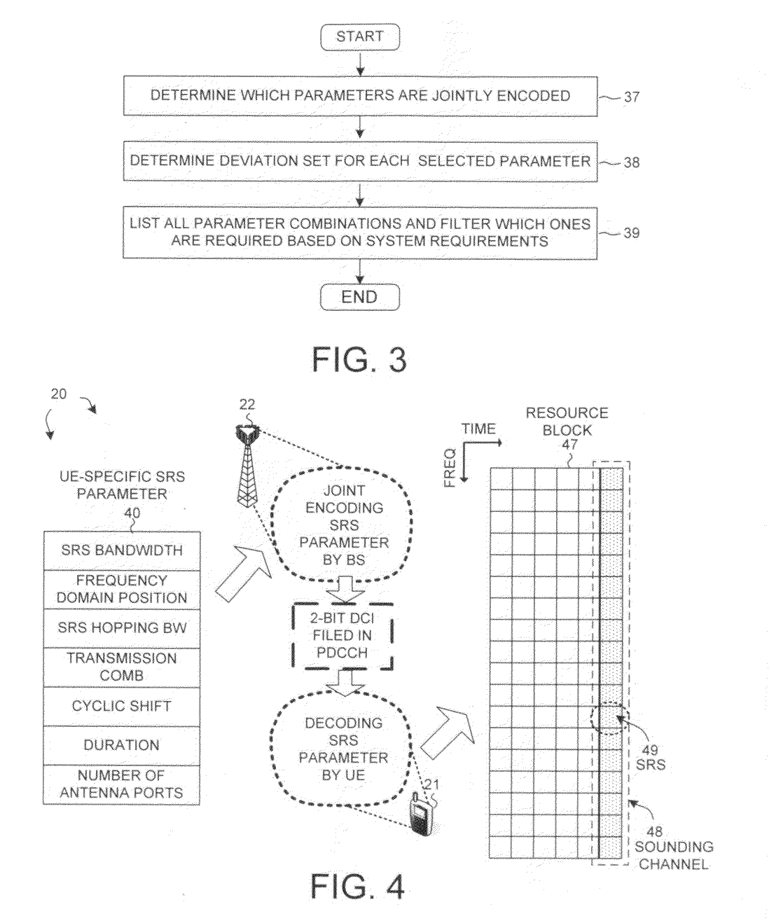

FIG. 3 is a flow chart of a method of joint encoding for ap-SRS parameters by an eNB in accordance with one novel aspect. The eNB first determines which SRS parameters are jointly encoded (step 37). The other non-selected SRS parameters are directly configured by RRC. Next, the eNB determines a deviation set for each selected parameter (step 38). In general, for a parameter whose value is 0<=x<N, it can be re-configured by only using a deviation value, which is chosen from a set {a, b, . . . , c} where c<N. The deviation set may be configured by RRC. By using the deviation set, the possible re-configured values of the parameter are ((x+y) mod N) if x+y>=0 or ((N+x+y) mod N) if x+y<0, where y is a value of the deviation set. By using a deviation set for each selected parameter, the number of parameter combinations can be reduced. For example, there are two parameters 0<=x1<2 and 1<=x2<3. Suppose that for parameter x1, the deviation set is {0, 1}, and for parameter x2, the deviation set is {0}. The total parameter combinations for x1 and x2 thus include two possible combinations: {(x1 mod 2), (x2 mod 3)} and {((x1−1) mod 2), (x2 mod 3)}. As a result, only one bit is required to encode the two combinations for parameters x1 and x2. In step 39, the eNB list all possible parameter combinations and filter the combinations base on system requirement such that only the necessary parameter combinations are jointly encoded using the n-bit DCI field for signaling. Other unnecessary parameter combinations are discarded because of the limited number of signaling bits (e.g., n=2) for good PDCCH coverage.

FIG. 4 illustrates a process of uplink channel sounding using ap-SRS via joint encoding/decoding in LTE-A system 20. In LTE-A systems, because cell-specific SRS parameters of p-SRS can be re-used for ap-SRS, only UE-specific parameters need to be selected for joint encoding for ap-SRS. For example, all UE-specific SRS parameters are selected for joint encoding, as illustrates in table 40 of FIG. 4. For each selected parameter, a deviation set is then determined. For example, a full set is selected for each UE-specific SRS parameter. At the eNB side, based on the selected parameters and the deviation sets, eNB22 then lists all possible parameter combinations and filter only those necessary combinations based on system requirements because only n bits are used for encoding the combinations. For example, if a UE has a demand on high-rate transmission and so requires a larger transmission bandwidth, its sounding bandwidth also should be large to estimate channel in the corresponding bandwidth. As a result, the parameter combinations with small sounding bandwidth should be discarded. At the UE side, UE21 receives the signaling bits and decodes the selected parameters accordingly. Based on the decoded parameters, UE21 allocates a sounding channel 48 in radio resource block 47, and transmits a sounding signal 49 via sounding channel 48, as illustrated in FIG. 4.

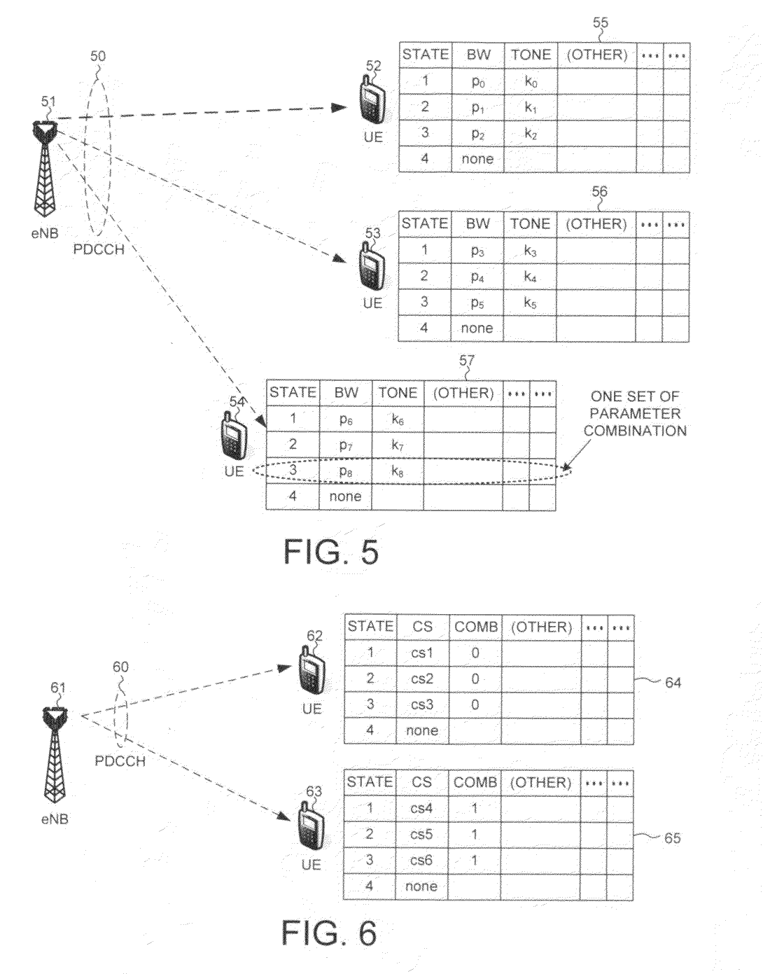

FIG. 5 illustrates a first embodiment of a signaling method for uplink channel sounding using joint encoding. In the example of FIG. 5, eNB51 uses two signaling bits (n=2) to re-configure UE-specific ap-SRS parameters for UE52, UE53, and UE54 via PDDCH 50. Two UE-specific parameters are selected, one is SRS bandwidth (e.g., BW), and the other one is frequency domain position (e.g., TONE) as depicted in tables 55, 56, and 57. The two signaling bits can indicate four states, including three states for three sets of parameter combinations plus one state for no triggering of ap-SRS. Each of the three states indicates one parameter combination of SRS bandwidth and frequency domain position. For example, for UE52, State 1 indicates BW=p0 and TONE=k0, State 2 indicates BW=p1 and TONE=k1, State 3 indicates BW=p2 and TONE=k2, and State 4 indicates no activation, as depicted in table 55. Similarly, table 56 and table 57 depict the different states representing different parameter combinations for UE53 and UE 54 respectively.

FIG. 6 illustrates a second embodiment of a signaling method for uplink channel sounding using joint encoding. In the example of FIG. 6, eNB61 uses two signaling bits (n=2) to re-configure UE-specific ap-SRS parameters for UE62 and UE63 via PDDCH 60. Two UE-specific parameters are selected, one is cyclic shift option (e.g., CS), and the other one is transmission comb (e.g., COMB) as depicted in tables 64 and 65. Similar to FIG. 5, the two signaling bits indicate four states, including three states for three sets of parameter combinations for CS and COMB plus one state for no triggering of ap-SRS. For example, for UE62, State 1 indicates CS=cs1 and COMB=0, State 2 indicates CA=cs2 and COMB=0, State 3 indicates CS=cs3 and COMB=0, and State 4 indicates no activation, as depicted in table 64. Similarly, table 65 depicts the different states representing different parameter combinations of CS and COMB options for UE63. From the above illustrated examples, it can be seen that by jointly encoding selected SRS parameters, the eNB can dynamically re-configure ap-SRS parameters and resources for each UE with high flexibility and efficiency.

In 3GPP LTE-A release 10, multi-antenna sounding is supported for uplink MIMO. In multi-antenna sounding, a UE transmits sounding signals from each antenna, and an eNodeB chooses the best precoding weights (vectors/matrices) to be used for each antenna of the UE based on CSI measured by the sounding signals, such that the UE can perform close-loop MIMO in uplink transmission for each antenna. For uplink MIMO, multi-antenna SRS resource allocation is thus required to allocate SRS resource for each antenna of each UE. For each antenna, two important SRS parameters to be configured via an RRC message include a cyclic shift (CS) option and a transmission comb option. In current LTE systems, eight CS options are provided for generating eight orthogonal Zadoff-Chu (ZC) sounding sequences, and two transmission combs are provided for alternating frequency tones in a sounding channel. As a result, the RRC message carries four bits to configure these two parameters for each antenna. If SRS resource is explicitly allocated antenna-by-antenna, then signaling overhead linearly increases as the number of antennas increases. In accordance with one novel aspect, an implicit multi-antenna SRS resource allocation is proposed to reduce such signaling overhead.

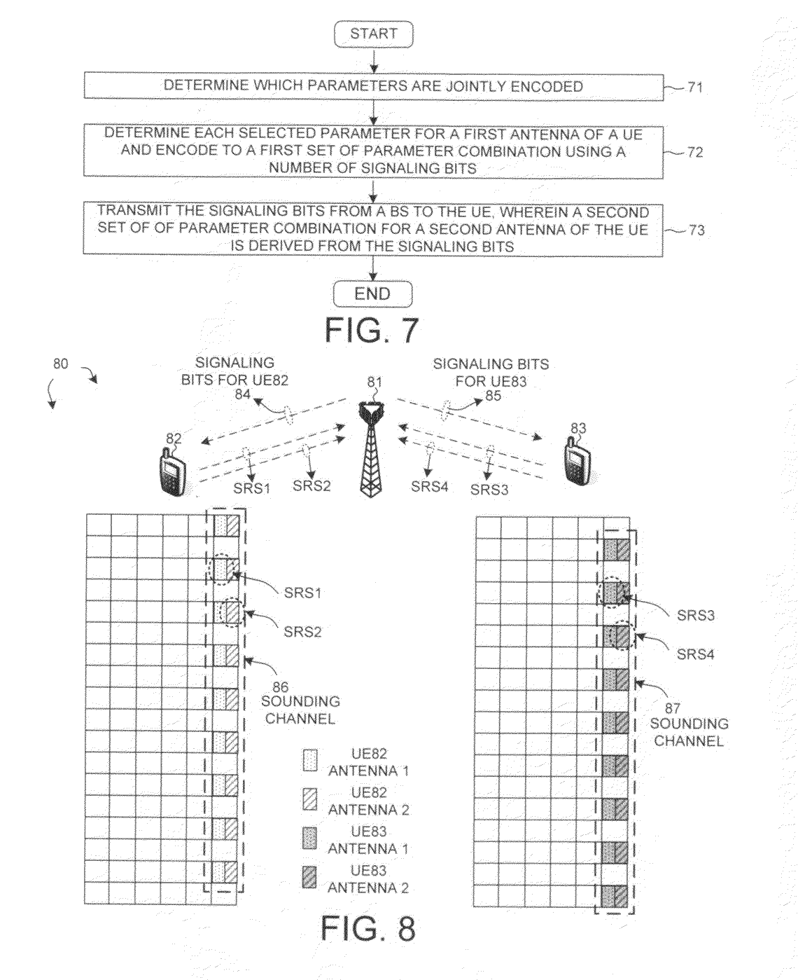

FIG. 7 is a flow chart of a method of implicit signaling for multi-antenna SRS resource allocation by an eNB in accordance with one novel aspect. The eNB first determines which SRS parameters are jointly encoded for multi-antenna resource allocation (step 71). For example, the eNB may select the cyclic shift (CS) option and the transmission comb option for joint encoding. Next, the eNB determines a first set of parameter combination for a specific antenna of a UE (step 72). For example, the first set of parameter combination for a first antenna may be a specific CS option and a specific transmission comb option (e.g., CS₁=1, comb₁=0). The first set of parameter combination is encoded using a number of signaling bits (e.g., three bits for CS and one bit for comb). In step 73, the eNB transmits the signaling bits to the UE. In general, the other sets of parameter combinations for the other antennas of the same UE can be derived based on a predetermined rule and the same signaling bits. For example, if a first set of parameter combination for the specific antenna is transmissionComb and cyclicShift, then the kth set of parameter combination for the kth antenna may be derived as combₖ=(transmissionComb+αₖ) mod 2, and CSₖ=(cyclicShift+βₖ) mod 8. As a result, only one set of parameter combination for one antenna is required to be encoded and be transmitted to the UE having multiple antennas. The UE can derive the other sets of parameter combinations for the other antenna based on the predetermined rule. The predetermined rule (e.g., αₖ and βₖ) are known at the UE side, which may either be fixed or be configured via RRC.

FIG. 8 illustrates an implicit signaling method for multi-antenna SRS resource allocation in a wireless LTE-A system 80. Wireless LTE-A system 80 comprises a base station (eNB) 81, and two user equipments UE82 and UE83. UE82 and UE83 each has two antennas. For a specific antenna of each UE (e.g., the first antenna in general), eNB81 determines a set of SRS parameter combination and encodes the parameter combination using a number of signaling bits. For example, signaling bits 84 for antenna 1 of UE82 indicate CS=0 and comb=0, and signaling bits 85 for antenna 1 of UE83 indicate CS=1 and comb=1. Signaling bits 84 and 85 are then transmitted to UE82 and UE83 respectively. Under an implicit signaling method, eNB81 does not transmit additional signaling bits to configure the second antenna of each UE. Instead, UE82 and UE 83 derive SRS parameter combinations for their second antennas based on the same signaling bits and a predetermined rule. For example, UE82 determines that the parameter combination for its second antenna is CS=4 and comb=0, and UE83 determines that the parameter combination for its second antenna is CS=5 and comb=1.

Under this implicit signaling method, UE82 transmits sounding signal SRS1 having a Zadoff-Chu code sequence with CS=0 via a sounding channel 86 with comb=0 (e.g., with odd frequency tone position). UE82 also transmits sounding signal SRS2 having a Zadoff-Chu code sequence with CS=4 via the same sounding channel 86 with comb=0. Similarly, UE83 transmits sounding signal SRS3 having a Zadoff-Chu code sequence with CS=1 via a sounding channel 87 with comb=1 (e.g., with even frequency tone position). UE83 also transmits sounding signal SRS4 having a Zadoff-Chu code sequence with CS=5 via the same sounding channel 87 with comb=1. Such implicit signaling method may be used for both p-SRS and ap-SRS resource allocation. For configuring p-SRS, the eNB transmits the signaling bits via RCC. For triggering ap-SRS, the eNB transmits the signaling bits contained in DCI via PDCCH, as illustrated above with respect to FIG. 6.

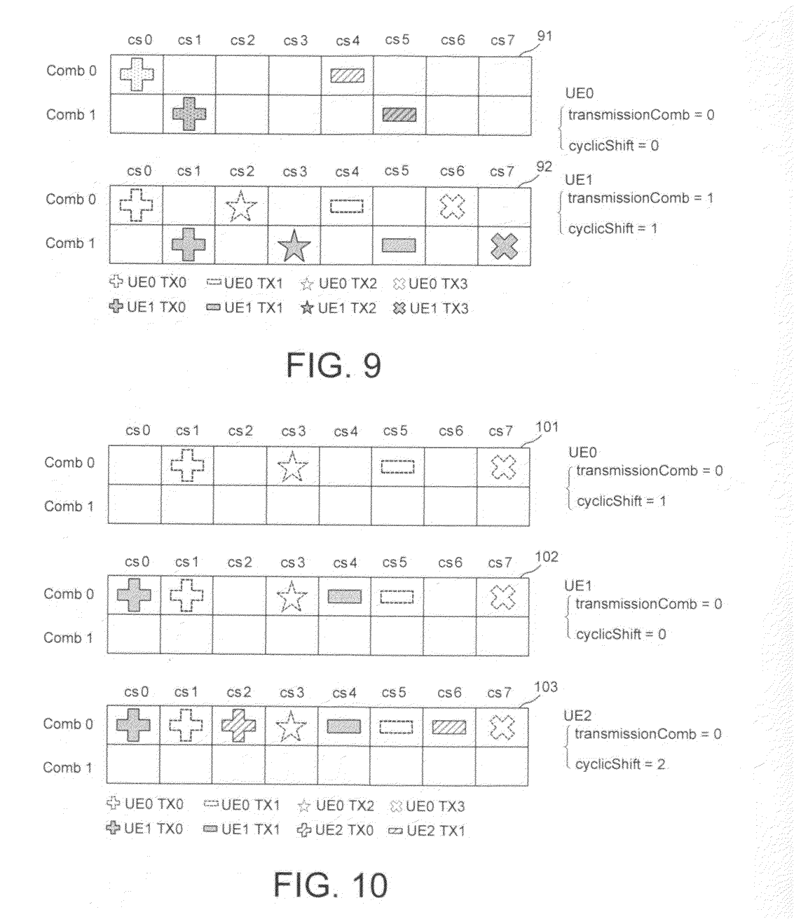

FIG. 9 illustrates a first embodiment of implicit signaling for multi-antenna SRS resource allocation by an eNB in a wireless communication system. In the example of FIG. 9, the implicit signaling is based on the following predetermined rule:

combₖ=(transmissionComb+αₖ) mod 2

CSₖ=(cyclicShift+βₖ) mod 8

where:

α0=α1=α2=α3=0

β0=0 for 1TX (1 antenna)

β0=0 and β1=4 for 2TX (2 antennas)

β0=0, β1=4, β2=2, and β3=6 for 4TX (4 antennas)

The top table 91 of FIG. 9 illustrates SRS resource allocation for UE0 and UE1, both having two antennas (e.g., TX0 as the first antenna and TX1 as the second antenna). UE0 receives signaling information from the eNB that allocates SRS'parameters with transmissionComb=0 and cyclicShift=0. Based on this signaling information and the predetermined rule, UE0 derives the following SRS parameters for sounding signal transmission:

CS0=0 and Comb0=0 for TX 0

CS1=4 and Comb1=0 for TX1

Similarly, UE1 receives signaling information from the eNB that allocates SRS parameters with transmissionComb=1 and cyclicShift=1. Based on this signaling information and the predetermined rule, UE0 derives the following SRS parameters for sounding signal transmission:

CS0=0 and Comb0=0 for TX0

CS1=4 and Comb1=0 for TX1

The bottom table 92 of FIG. 9 illustrates the SRS resource allocation for UE0 and UE1, both having four antennas. UE0 and UE1 receive the same signaling information from the eNB for SRS resource allocation as illustrated above with respect to table 91. Based on the signaling information and the predetermined rule, the following SRS parameters are derived by UE0 and UE1 for sounding signal transmission:

For UE0:
CS0=0, CS1=4, CS2=2, and CS3=6
Comb0=Comb1=Comb2=Comb3=0

For UE1:
CS0=1, CS1=5, CS2=3, and CS3=7
Comb0=Comb1=Comb2=Comb3=1

FIG. 10 illustrates a second embodiment of implicit signaling for multi-antenna SRS resource allocation by an eNB in a wireless communication system. The implicit signaling in FIG. 10 is based on the same predetermined rule as illustrated above with respect to FIG. 9. In the example of FIG. 10, however, the different antennas of different UEs are evenly separated with maximal possible CS spacing along the CS domain. For UE0, as illustrated in table 101, the four antennas (TX0-TX3) of UE0 are evenly separated with CS=1, 3, 5, and 7. For UE0 and UE1, as illustrated in table 102, the four antennas of UE0 (TX0-TX3) and two antennas of UE1 (TX0-TX1) are evenly separated with CS=0, 1, 3, 4, 5, and 7. For UE0, UE1, and UE2, as illustrated in table 103, the four antennas of UE0 (TX0-TX3), two antennas of UE1 (TX0-TX1), and two antennas of UE2 (TX0-TX1) are evenly separated with CS=0, 1, 2, 3, 4, 5, 6, and 7. In this way, it is easy for the eNB to multiplex different antennas from different UEs in the CS domain with reduce overhead. The best orthogonality between sounding signals from different antennas of different UEs is kept.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method of resource allocation for a sounding channel in a wireless communication system, the method comprising:
selecting a number of parameters from a plurality of sounding reference signal (SRS) parameters;
determining a deviation set for each selected SRS parameter; and
jointly encoding the selected number of parameters using a number of signaling bits, wherein some parameter combinations are filtered based on system requirements such that the number of signaling bits is limited to a predefined number.

2. The method of claim 1, wherein the number of signaling bits is equal to two, and wherein the selected parameters comprises an SRS bandwidth, the number of antennas, and an SRS frequency domain position.

3. The method of claim 1, wherein the signaling bits are contained in downlink control information (DCI) and sent by a base station via a physical downlink control channel (PDCCH).

4. The method of claim 3, wherein the PDCCH is sent to a user equipment (UE) for triggering Aperiodic SRS (ap-SRS), and wherein the signaling bits are used to configure UE-specific SRS parameters for the sounding channel.

5. The method of claim 4, wherein the base station also configures the UE for transmitting periodic SRS (p-SRS), wherein the ap-SRS and the p-SRS have the same cell-specific parameters, and wherein the ap-SRS and the p-SRS share the same allocated radio resource.

6. The method of claim 5, wherein the ap-SRS and the p-SRS have different UE-specific parameters, and wherein the ap-SRS and the p-SRS are multiplexed within the allocated radio resource.

7. The method of claim 1, wherein the selected number of parameters are jointly encoded into multiple sets of parameter combinations for a user equipment (UE).

8. The method of claim 1, wherein the selected parameters comprises a cyclic shift (CS) option for SRS sequence and a transmission comb option.

9. The method of claim 8, wherein the signaling bits is encoded for a specific antenna of a user equipment (UE), and wherein the selected parameters for other antennas of the UE are derived by the UE based on the same signaling bits.

10. A base station in a wireless communication system, comprising:
an information encoding module that jointly encodes a selected number of sounding reference signal (SRS) parameters into a number of signaling bits, wherein some parameter combinations are filtered based on system requirements such that the number of signaling bits is limited to a predefined number;
a transceiver that transmits the number of signaling bits to a user equipment (UE), wherein the transceiver also receives sounding signals via a sounding channel from the UE, and wherein the sounding signals and the sounding channel are configured based on the signaling bits; and
a channel estimation module that performs channel estimation based on the received sounding signals.

11. The base station of claim 10, wherein the number of signaling bits is equal to two, and wherein the selected parameters comprises an SRS bandwidth, the number of antennas, and an SRS frequency domain position.

12. The base station of claim 10, wherein the signaling bits are contained in downlink control information (DCI) via a physical downlink control channel (PDCCH) for triggering Aperiodic SRS (ap-SRS).

13. The base station of claim 12, wherein the base station configures the UE for transmitting periodic SRS (p-SRS), wherein the ap-SRS and the p-SRS have the same cell-specific parameters, and wherein the ap-SRS and the p-SRS share the same allocated radio resource.

14. The base station of claim 13, wherein the ap-SRS and the p-SRS have difference UE-specific parameters, and wherein the ap-SRS and the p-SRS are multiplexed within the allocated radio resource.

15. The base station of claim 10, wherein the selected number of parameters are jointly encoded into multiple sets of parameter combinations for a user equipment (UE).

16. A method of for providing a sounding channel in a wireless communication system, the method comprising:
receiving a number of signaling bits from a base station by a user equipment (UE);
decoding the signaling bits into a selected number of sounding reference signal (SRS) parameters, wherein the selected number of SRS parameters are jointly encoded using the signaling bits based on system requirements such that the number of signaling bits is limited to a predefined number; and
allocating a sounding channel and transmitting SRSs via the allocated sounding channel based on the decoded SRS parameters.

17. The method of claim 16, wherein the number of signaling bits is equal to two, and wherein the selected parameters comprises an SRS bandwidth and an SRS frequency domain position.

18. The method of claim 16, wherein the signaling bits are contained in downlink control information (DCI) via a physical downlink control channel (PDCCH) for triggering Aperiodic SRS (ap-SRS).

19. The method of claim 16, wherein the selected number of parameters are jointly encoded into multiple sets of parameter combinations for a user equipment (UE).

20. The method of claim 16, wherein the selected parameters comprises a cyclic shift (CS) option for SRS sequence and a transmission comb option.

21. The method of claim 20, wherein the UE receives a first set of signaling bits for a first antenna, and wherein the UE derives the selected parameters for a second antenna based on the first set of signaling bits and a pre-defined rule without receiving additional signaling bits.
